(19) United States
(12) Patent Application Publication
(10) Pub. No.: US 2004/0225380 A1
(43) Pub. Date: Nov. 11, 2004

(54) System and method for controlling the operating functions of a cycle, corresponding units and computer program product

(75) Inventor: Gianfranco Guderzo, Arzignano (IT)

Correspondence Address: VOLPE AND KOENIG, P.C., UNITED PLAZA, SUITE 1600, 30 SOUTH 17TH STREET, PHILADELPHIA, PA, 19103, US

(73) Assignee: Campagnolo S.r.l., Vicenza (IT)

(21) Appl. No.: 10/806,569

(22) Filed: Mar. 22, 2004

(30) Foreign Application Priority Data
Mar. 21, 2003 (EP) 03425181.9

(51) Int. Cl. G06F 1/30; G06F 1/28; G06F 1/26; G06F 17/00; G05B 15/00; G05B 11/01

(52) U.S. Cl. 700/19; 700/83; 700/90

(57) ABSTRACT

In an electronic control system for cycles, for example competition bicycles, which comprises a display unit, a control unit and a power unit for governing actuators provided on the cycle, for instance a gear shift actuator, in absence of said display unit, the control unit and the power unit are able to ensure performance of a set of basic locomotion functions, such as an upwards and downwards gear shifting and an upwards and downwards derailleur shifting.

### FIELD OF INVENTION

The present invention relates to control systems for cycles and has been developed with particular attention to competition bicycles.

### BACKGROUND

Electronic control systems are a new and important aspect of cycling. Such electronic control systems perform a variety of functions, including receiving and processing information gathered by sensors usually distributed on the rider and/or cycle. These sensors obtain information on the operation/running conditions of the rider and/or cycle.

These electronic control systems allow the user to control actuators of different sorts on the bicycle. This allows a rider to modify, either manually or automatically, depending on given criteria, the aforesaid operation/running conditions of the cycle. For example, an electronic control system can control the gear shift and the derailleur shift of a cycle by means of electrical actuators.

Display units both process and display information to the rider regarding the operation/running condition of the cycle. These display units typically comprise a processor with storage capacity (a computer), in which sensitive information specific to the rider is stored.

FIG. 1 illustrates the structure of a known electronic control system 1 destined for equipping a cycle (not illustrated). The system 1 is made up of a set of functional blocks interconnected that communicate with each other.

The system 1 comprises a display unit 11 that functions as an interface for display and management of the system. It provides visual information to the user, and enables setting different modes of the electronic control system 1. The display unit 11 also incorporates cycle-computer functions that can be controlled through push-buttons 20, and interacts through a connection 101 with the remaining part of the electronic control system 1 for performing functions of initialization and pre-setting.

By means of the connection 101, the display unit 11 is in signal and power electrical connection with a control unit 12 that interfaces and as a module for management of the requests made by the user, enabling conversion of the requests issued by the user both for positioning the gear shift and the derailleur. Such requests are generated by operating a push-button 18 corresponding to the derailleur and a push-button 19 corresponding to the gear shift. The depression of these buttons 18, 19 generates signals or communication frames that are then sent to a power unit 13 able to carry out said requests.

The control unit 12 also sends communication frames or signals to the power unit 13 by means of a connection 102. The power unit 13 typically controls mechanical movements on the cycle, such as members for servo-assisted operation. Such servos move the gear shift and the derailleur of the cycle.

The power unit 13 manages the positioning requests for the gear shift and for the derailleur, and controls operation of a gear shift actuator 14 and a derailleur actuator 15, which are associated to respective position transducers 16 and 17. The position transducers 16 and 17 provide information on the position of the gear shift and of the derailleur to the power unit 13 to enable optimal control of the actuators 14 and 15. With the gear shift's and derailleur's position known, the power unit executes procedures according to particular requirements that may be necessary for the cycle. These include zero-setting of the position of the actuators and adjusting settings to account for position drifts or offsets in the gear shift or derailleur.

The display unit 11 can be removed from the control unit 12, the power unit 13, and the cycle frame.

An electronic control system of this type is known, for instance, from the Italian patent application TO2000A000293 U.S. patent application Ser. No. 09/805,113 (publication number US2001-0027495) assigned to Campagnolo S.r.l., the contents of which is incorporated by reference as if fully set forth herein.

The electronic control systems of this type known to the prior art are not in general able to operate in absence of the display unit. In particular, rather, the system described in the above indicated patent application detects the removal of the display unit 11. In the event of its removal, the electronic control system is no longer usable, and the microcontroller of the control unit disables the electronic control system.

Removing the display unit, however, occurs with some frequency. It may be removed by theft, or else loss of the display unit may follow an impact or fall. The control system of the cycle would thus remain disabled, and prevent the user not only from knowing the operation/running conditions of the cycle, but also prevent modifying the aforesaid operation/running conditions of the cycle. In particular, the user could find himself prevented from using the gear shift of the cycle. Such circumstance could also arise if the display unit malfunctioned.

### SUMMARY

The object of the present invention is to prevent the drawbacks outlined above and to propose a solution that will provide an operable electronic control system in the absence of the display unit. The reference to cycles, and in particular to the racing bicycles, is not to be meant in any way as limiting the possible fields of application of the invention

According to the present invention, such an object is achieved by means of a system for controlling the operating functions of a cycle and a corresponding method, and a corresponding program method for performing the method of the invention on a computer.

Substantially, the solution according to the invention foresees that, even in the condition of removal of the display unit, the fixed part of the system will be able to ensure execution of at least some of the basic functions corresponding to the locomotion of the cycle, such as typically the functions corresponding to the gear shift and to the derailleur. In this way, the control system continues to react to the activation of the commands, and preferably this occurs according to modalities of operation that do not differ appreciably from the modalities of operation ensured by the system when the display unit is regularly associated to the system.

### BRIEF DESCRIPTION OF THE DRAWING(S)

The invention will now be described, purely by way of non-limiting example, with reference to the drawings.

FIG. 1 shows a system for controlling the operating functions of a cycle according to the prior art.

FIGS. 2 through 5 show flowcharts for the present method for controlling the operating functions of a cycle.

### DETAILED DESCRIPTION OF THE PREFERRED EMBODIMENT(S)

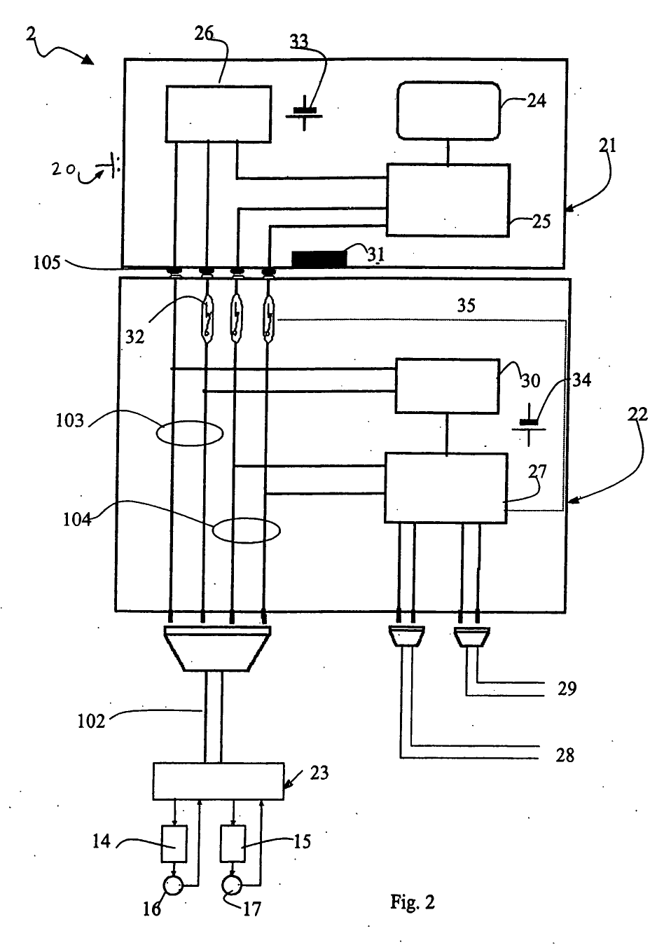

FIG. 2 illustrates the partial block diagram of a system 2 for controlling the operating functions of a cycle.

Such system refers, in general terms, to the basic diagram of the system 12 already described previously.

The system 2 thus comprises a display unit 21, a control unit 22 and a power unit 23.

The power unit 23 supplies the control unit 22 by means of a connection 102, which comes under a supply bus 103 and a communication bus 104. A connection 105 of the disconnectable type extends the supply bus 103 and the communication bus 104 to the display unit 21.

The disconnectable connection 105 can be obtained by a suitable four-conductor male-female connector, or else by sliding contacts.

The microcontroller 27 is connected in parallel on the communication bus 103 in the control unit 22. The microcontroller 27 has inputs 28 and 29 for receiving respective commands corresponding to the gear shift and to the derailleur. The microprocessor 27 thus provides for forwarding said commands, on the communication bus 104, to the power unit 23. The control unit 22 includes an auxiliary supply circuit 30, which monitors, in a known way, operation of an auxiliary battery 34 for the microcontroller 27.

The display unit 21 includes a display 24 that is driven by a microprocessor 25. Said microprocessor 25 is suitable for performing the cycle-computer functions and for communicating by means of the communication bus 104 with the control unit 22. An auxiliary supply circuit 26 monitors, in a known way, operation of an auxiliary battery 33 for the microcontroller 25.

The display unit 22 further comprises a magnet 31, while the control unit 22 has three magnetic switches 32 of the reed type, i.e. which are activated by the presence of the magnet 31. The magnetic switches 32 are placed on the communication bus 104 and one conductor of the supply bus 103. The magnet 31 keeps said magnetic switches 32 closed. In the present configuration, should the display unit 21 be removed from the cycle, the magnet 31 moves away from the magnetic switches 32, and the switches 32 open.

Interruption of the connection 105 thus interrupts communication of the signals and the supply between the control unit 22 and the display unit 21. Opening of the circuit via the switches 32 then has the effect of electrically insulating the control unit 22 with respect to the contacts (distal segments) of the connection 105, segments which may be seen in FIG. 2 in the area comprised between the blocks representing the units 21 and 22, which may remain exposed as a result of the removal of the display unit 21.

Said solution, and the advantages that derive therefrom, are described in detail way in a European patent application No. 03425180.1 filed on Mar. 21, 2003 and U.S. patent application Ser. No. ______ filed on Mar. 22, 2004, which are incorporated by reference as if fully set forth herein. Both applications are assigned to Campagnolo, S.r.l., the assignee of the present application.

The microcontroller 27 of control unit 22 can then be connected by a signal line 35 to the switches 32 so as to enable detection of the condition of operation, i.e., open or closed condition.

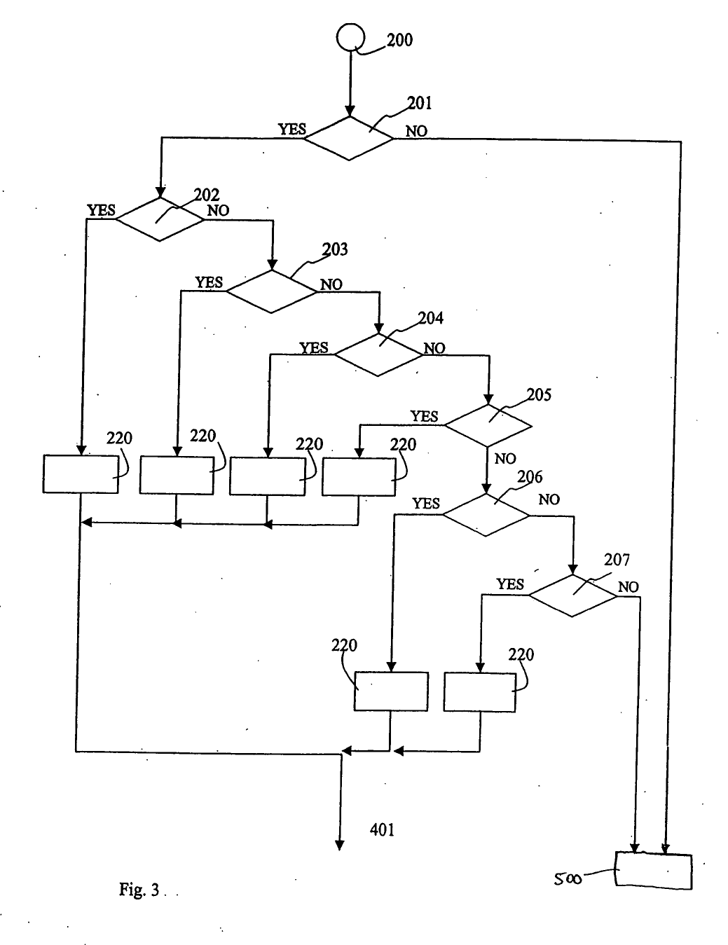

FIGS. 3, 4 and 5 illustrate, by way of example, the flowcharts corresponding to the method for controlling the operating functions of a cycle control implemented in the electronic control system 2.

FIG. 3 illustrates the part of procedure corresponding to the display unit 21.

Here, starting from an initial step 200, the choice step 201 identifies the operation of requesting whether the user wishes to enter programming mode.

If answered in the negative, the control goes to end of procedure 500. If answered in the affirmative, the control goes to a set of choice steps from 202 to 207, which are implemented in conditioned sequence and which, if the answer “ES” is given (whatever the step considered between 202 and 207), lead to performing a step 220 for sending the request to the power unit 23.

Specifically, step 202 corresponds to the request as to whether the user wishes to proceed to a step for resetting the actuator to a home, or zeroed, position. The setting of such a position is described in detail in U.S. application Ser. No. 10/664,305 filed on Sep. 16, 2003 which is incorporated by reference as if fully set forth.

In the negative, at step 202, the control passes to a choice step 203, where the user is asked whether he wishes to exit the zero-setting step.

In the negative, at step 203, the control passes to step 204, which asks the user whether he wishes to proceed to a compensation step. The compensation step 203 addresses misalignments in the gearshift between the chain and one or more sprockets of the gearshift. The compensation step receives information on the desired alignment between the chain and a predetermined sprocket of the gearshift; and setting an adjustment variable, of a logic value associated with the gear ratio relative to the predetermined sprocket, to a value corresponding to the displacement carried out in driving the actuator. This compensation step is described in detail in U.S. application Ser. No. 10/663,231 filed on Sep. 16, 2003, which is herein incorporated by reference as if fully set forth.

In the negative, at step 204, the control passes to step 205, where the user is asked whether he wishes to exit from the compensation step.

In the negative, at step 205, the control passes to step 206, where the user is asked whether the manual mode of operation is to be set.

In the negative, at step 206, the control passes to step 207, where the user is asked whether the automatic mode of operation is to be set.

In the negative, at step 207, the control passes to end of procedure 500.

The choice steps above mentioned are performed by operating the push-buttons 20 of the display unit 21 of FIG. 2.

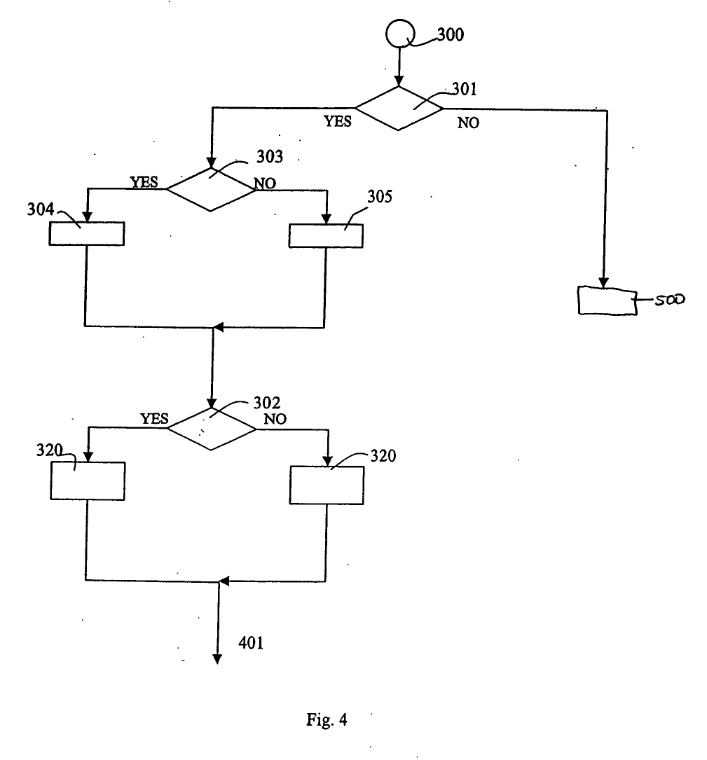

FIG. 4 illustrates the part of procedure corresponding to the control unit 22.

Here, initially, in a choice step 301 there is executed the operation asking whether a command is present at input, i.e., at the inputs 28 and 29, as a result of operation of the controls 18 and 19.

In the negative, the control goes to end of procedure 500.

In the affirmative, the control passes to a choice step 303, which evaluates whether the display unit 21 is present, i.e., connected to the control unit 22.

In the affirmative, there is executed an operation, designated by block 304, for setting a signalling register or flag. Such flag, when set, indicates the presence of the display unit 22.

If the display unit 22 is not present, there follows an operation, designated by block 305, for resetting said flag, so that it indicates that the display unit 22 is not present.

In either case, the control then passes to a choice step 302, which evaluates whether the command is directed to the gear shift (exit YES) or the derailleur (exit NO).

In either case, there is executed a step, designated by block 320, for sending the corresponding request to the power unit 23. Such request comprises information on the presence or not of the display unit 22 obtained via steps 304 and 305.

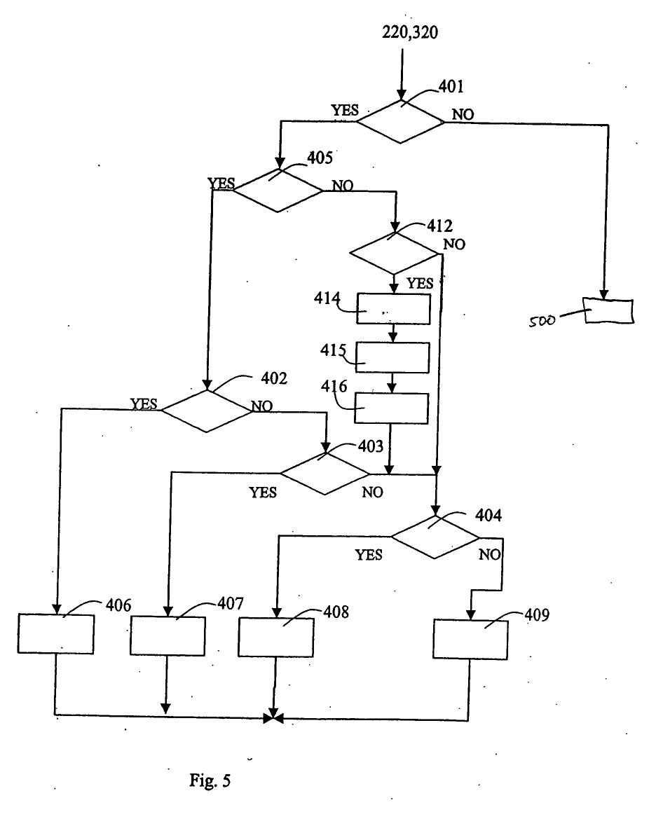

FIG. 5 illustrates the part of procedure corresponding to the power unit 23.

Here, initially, a choice step 401 is executed, which involves the operation of evaluating whether a command is present at input, forwarded by the steps of blocks 220 and 320.

In the negative, the control goes to the previous step, subsequent step, or a to the beginning of the process. These options are called the end of procedure 500 herein, but are not meant to imply that the procedure being run ceases to run. The end of procedure is the termination point for certain negative decisions.

In the affirmative, the control passes to a choice step 405, which evaluates whether the display unit 21 is present, i.e., connected to the control unit 22, in particular on the basis of the request coming from blocks 320.

If the display unit 21 is present, the control passes to a choice step 402, which evaluates whether the command detected at input requests execution of a step for zero-setting of an actuator.

In the affirmative, the control passes to a block designated by 406, in which the operation of displacement of the actuator is executed as long as the command is present at input to block 401.

In the negative, the control passes to a block 403, which evaluates whether the command requests execution of a step for compensation of the position of an actuator.

In the affirmative, the control passes to a block designated by 407, in which the operation of compensation of the actuator is executed as long as the command is present at input to block 401.

In the negative, the control passes to a choice step 404, which evaluates whether the command is of manual or automatic type.

In the case of a manual command, there is executed an operation of positioning according to the request set manually, such operation being indicated in a block 408.

In the case of an automatic command, there is executed an operation of positioning according to a pre-set sequence, such operation being indicated by a block 409.

In the case where, instead, the choice step 405 yields a negative result, i.e., the display unit is not present, the control passes to a choice step 412, which evaluates whether the command detected at input requests execution of a step corresponding to the choice of a operation mode or setting of a parameter.

In the affirmative, the control passes to a block, designated by 414, in which the values corresponding to the last parameter values already stored are re-loaded, said values being regarded in any case as reliable as compared to the uncertain state of the values that would appear upon removal of the display unit 21 during a procedure of choice of parameters.

Therefore, in a block 415, there is performed the operation of resetting the operating mode, which stops the procedure (in particular the zero-setting or compensation step) that was running. Once the system recognizes that the display unit is missing, it first reloads the last reliable values it has (block 414), it then stops the procedure that was running (block 415) and finally puts itself in the “basic” or normal way of working in block 416.

In the negative, the control passes to the choice step 404.

Consequently, from what has been illustrated so far, the operation proceeds as follows.

When the display unit 21 is removed, as has been said, the connection line 105 is interrupted and the control unit 22 can no longer receive commands from the display unit 21; namely, it can no longer transfer the requests in blocks 220 from the display unit 21 to the power unit 23.

The procedures corresponding to the control unit 22 and to the power unit 23 are, however, organized so as to maintain operative a set of basic locomotion functions. In particular, procedures control the gear shift and the derailleur, so as to permit control of same even with the display unit 21 removed, so that, for instance, the commands that appear at the choice step 301, imparted by the push-buttons 18 and 19, are received from the control unit 22 and forwarded to the corresponding choice step 401 relating the power unit 23.

The control system 2 therefore continues to operate only according to a basic or normal operating mode.

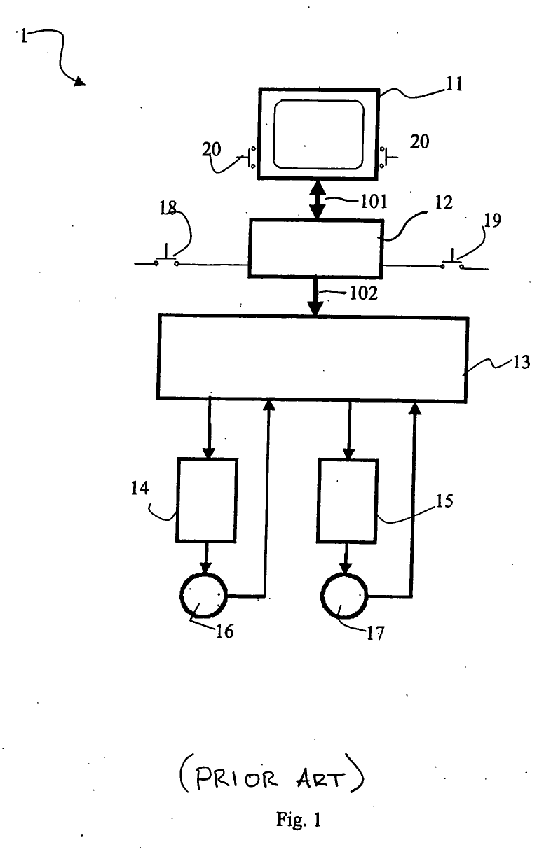

For instance, there will still remain the possibility of sending the commands by the push-buttons 18 and 19, see FIG. 1, for performing a gear shift and a derailleur shift.

More specifically, in presence of a removal of the display unit 21, it is foreseen to maintain active:

normal operation in manual mode: corresponding to operation of the commands there is the positioning of the gear shift or of the derailleur in step 408; and

normal operation in automatic mode: corresponding to operation of the push-buttons on the gear shift side there is the positioning of the gear shift and/or of the derailleur, according to a pre-determined sequence.

The choice steps regarding operation mode and setting of a parameter are concluded according to what is indicated with reference to FIG. 5, i.e., retrieving the old values stored and entering a normal-operation mode, which enables the upwards and downwards gear shifting and the upwards and downwards derailleur shifting.

The electronic control system proposed may advantageously be employed also in other situations, such as those of malfunctioning, theft or loss of the display unit. Thus, even inadvertent removal or malfunction of the display unit will not debilitate the control and power unit on the cycle.

Of course, without prejudice to the principle of the invention, the details of realization and embodiments may vary widely with respect to what is described and illustrated herein, without thereby departing from the scope of the present invention.

The embodiment of the invention described previously foresees that the basic functions of locomotion of the cycle will be performed by the reamining fixed part of the control system.

There are, however, solutions in which the display unit, equipped with a microcontroller of adequate power and resources (for instance, for developing, in addition to the normal functions typical of a cycle computer, GPS positioning functions or advanced mobile communication functions, such as UMTS) may, with only modest additional computational load, assume the role of controlling the functions of locomotion, such as operation of the gear shift and of the derailleur. This must likewise foresee the possibility that, in the case of removal of the display unit, the implementation of said functions will be transferred to the “fixed” part of the system, which is, for said purpose, equipped with corresponding “back-up” modules, that are activated when the display unit is removed from the cycle. In particular, such transfer of function may occur according to the typical modalities of a save operation of the type usually performed in an electronic processing system, hence without appreciable discontinuities of operation being perceivable to the user.

As regards the possible implementation modes, the system can be a control system, which is able to control the operating functions of a cycle and which comprises at least one first unit and one second unit that are able to co-operate functionally with one another, with the first unit being configured for being selectively removable from the cycle. The second unit is then configured for implementing the set of basic locomotion functions of the cycle, guaranteeing performance thereof (even) in conditions of removal of the first unit.

In addition or alternatively, the invention can also be realized by configuring, with an appropriate software, a programmable control system, which comprises at least one first unit and one second unit, which are able to co-operate functionally with one another, but should the first unit be removed from the cycle, causing the second unit to be able to implement the basic locomotion functions of the cycle, ensuring performance thereof in conditions of removal of the first unit from the cycle.

Furthermore, the system may comprise:

either a processing unit for a system for controlling the operating functions of a cycle, said processing unit being suitable for co-operating functionally with a further unit configured for being selectively removable from the cycle, where the processing unit is configured for implementing a set of basic locomotion functions, ensuring performance thereof in conditions of removal of said further unit from the cycle; or

a control unit for cycles for controlling the operating functions of a cycle, said control unit being configured for being selectively removable from the cycle and for co-operating with at least one complementary unit associated to the cycle, where associated to said control unit are means for detecting the removal of the unit from the cycle and signaling said removal to the complementary unit, enabling said complementary unit to implement a set of basic locomotion functions, ensuring performance thereof in conditions of removal of the control unit from the cycle.

What is claimed is:

1. A system for controlling the operating functions of a cycle, which comprises at least one first unit and one second unit, which are able to co-operate functionally with one another, said first unit being selectively removable from the cycle, said second unit implementing a set of basic locomotion functions, wherein the second unit performs the set of basic locomotion functions when said first unit is removed from the cycle.

2. The system of claim 1 wherein said set of basic locomotion functions comprises the function of controlling, through corresponding controls associated to the second unit, a first actuator controlling a gear shift of the cycle and a second actuator controlling a derailleur of the cycle.

3. The system of claim 2 wherein said function of controlling the first actuator and second actuator is enabled in a manual mode that permits manual operation of the actuators.

4. The system of claim 2 wherein said function of controlling the first and second actuator is enabled in a automatic mode that permits automatic operation of the actuators.

5. The system of claim 1 wherein said second unit comprises a microcontroller that performs said set of basic locomotion functions.

6. The system of claim 1 wherein said first unit is removably connected to said second unit by means of at least one electrical connection, which can be disconnected by leaving exposed on said second unit at least one contact part, and in that associated to said at least one electrical connection is at least one switch, which can be selectively actuated for electrical insulation of said exposed distal contact part from said second unit.

7. The system of claim 6 wherein said first unit comprises a magnet and in that said at least one switch is a switch that can be actuated magnetically by said magnet.

8. The system of claim 1 wherein said first unit is a display unit.

9. The system of claim 1 wherein said second unit comprises a control unit, associated to which are manually operated controls of the actuators and a power unit that drives said actuators.

10. A processing unit for controlling the operating functions of a cycle, designed for co-operating functionally with a further unit, said further unit being configured for being selectively removable from the cycle,
wherein said processing unit is configured for implementing a set of basic locomotion functions when said further unit is removed from the cycle.

11. A control unit for controlling the operating functions of a cycle, configured for being selectively removable from the cycle and for co-operating with at least one complementary unit associated to the cycle, comprising means for indicating its removal from the cycle to said complementary unit, enabling said complementary unit to implement a set of basic locomotion functions.

12. A method for controlling the operating functions of a cycle, which comprises the steps of:
providing a control system, which comprises at least one first unit and one second unit, which are able to co-operate functionally with one another;
configuring said first unit as a unit that is selectively removable from the cycle;
configuring said second unit for implementing a set of basic functions, ensuring performance thereof, in conditions of removal of said first unit from the cycle.

13. The method of claim 12 wherein said set of basic locomotion functions comprises the function of controlling an actuator corresponding to a gear shift of the cycle and an actuator corresponding to a derailleur of the cycle.

14. The method of claim 13 wherein it enables said function of controlling the actuator corresponding to a gear shift of the cycle and the actuator corresponding to a derailleur of the cycle in manual mode.

15. The method of claim 13 wherein it enables said function of controlling the actuator corresponding to a gear shift of the cycle and the actuator corresponding to a derailleur of the cycle in automatic mode.

16. The method of claim 12 wherein said set of basic functions are implemented by a microcontroller in said second unit.

17. The method of claim 12 wherein it foresees storing the requests of the first unit in said second unit and using the last instance of said requests of the first unit for ensuring performance of said basic locomotion functions.

18. A system for controlling the operating systems of a cycle comprising a display unit that allows a person to visually and manually interface with a control/power unit that controls at least one actuator that moves a part on a cycle, wherein the control/power unit is operable by the person through the display unit or in the absence or lack of functionality of the display unit, through the control/power unit.

19. The system of claim 18, wherein when the display unit is absent or not functional, the person operates the control/power unit using hand operable means.

20. The system of claim 19 wherein the hand operable means are buttons.

21. The system of claim 19 wherein the hand operable means are levers.

22. The system of claim 18, wherein when the display unit is absent or not functional, the person operates the control/power unit using a hand operable interface.

23. The system of claim 18 wherein the part of a cycle that moves is a derailleur.

24. The system of claim 18 wherein the part of a cycle that moves is a brake pad.

25. The system of claim 18 wherein the display unit directs the control/power unit to perform at least the following tasks:
a) resetting the home position of the actuator;
b) compensating for misalignments in the part;
c) allowing the person to manually operate the actuator; and
d) allowing the person to automatically operate the actuator.

26. The system of claim 18, wherein the control/power unit performs at least the following tasks the absence or lack of functionality of the display unit:
a) allowing the person to manually operate the actuator; and
b) allowing the person to automatically operate the actuator.

27. A cycle equipped with a system for controlling the operating functions of the cycle comprising at least one first unit and one second unit, which are able to co-operate functionally with one another, said first unit being selectively removable from the cycle, said second unit implementing a set of basic locomotion functions, wherein the second unit performs the set of basic locomotion functions when said first unit is removed from the cycle.

28. A computer program product directly loadable into the memory of a digital computer and comprising a means for implementing a set of advanced functions on a cycle and a means for implementing a set of basic functions on a cycle.

29. The computer program of claim 28, wherein the software is unable to implement advanced functions in the absence of a display unit.

30. A system for controlling the operating functions of a cycle, the system comprising:
at least one display unit that provides information regarding the functional operation of a cycle in human readable form; and
at least one control unit, which is functionally connected with and exchanges operational information with the at least one display unit regarding the cycle's locomotion functions and is capable of continuing to perform a set of basic locomotion functions if the connection with and exchange of operational information with the at least one display unit is interrupted.
